(19) United States
(12) Patent Application Publication
(10) Pub. No.: US 2011/0288813 A1
(43) Pub. Date: Nov. 24, 2011

(54) COORDINATE MEASURING APPARATUS AND METHOD

(75) Inventor: Yong Hwan KIM, Koyang-si (KR)

(73) Assignee: ANDAMIRO CO., LTD., Koyang-si (KR)

(21) Appl. No.: 12/783,646

(22) Filed: May 20, 2010

(51) Int. Cl. G01B 5/008

(52) U.S. Cl. 702/150; 356/614

(57) ABSTRACT

Disclosed herein is a coordinate measuring apparatus and method. Path equations of individual photodetection units relative to each light emitting unit are calculated using a plurality of photodetection units and a small number of light emitting units, and the coordinates of one or more actual targets are obtained using the calculated path equations. Accordingly, there are advantages in that, since a small number of light emitting sensors are used, installation costs can be reduced, maintenance costs can be reduced, and the lifespan of products can be extended.

### BACKGROUND OF THE INVENTION

1. Field of the Invention

The present invention relates, in general, to coordinate detection, and, more particularly, to a coordinate measuring apparatus and method, which can generate the coordinates of one or more actual target objects while using a small number of light emitting sensors.

2. Description of the Related Art

Generally, a touch screen denotes a screen enabling data to be directly input via a screen without using a keyboard so that, when a person's hand or a pointer touches a specific character displayed on the screen or a specific location on the screen, the location of the touch is detected and specific processing is performed by stored software.

A touch screen is implemented by attaching a device called a touch panel to the screen of a typical monitor, thus exhibiting a given function. Such a touch panel has the function of enabling invisible infrared rays to flow therethrough in horizontal and vertical directions to form a large number of rectangular gratings on the screen, thereby detecting the location where the tip of the finger or the pointer touches a specific grating. Therefore, when a user touches a character or an image previously displayed on a screen equipped with a touch panel, an item selected by the user is detected according to the location of the touch on the screen, and a command corresponding to the detected item is processed by a computer, thus allowing the user to easily obtain the desired information.

Thanks to these characteristics of a touch screen, a touch screen has been frequently used in guidance software in places frequently visited by the general public, such as subways, department stores, and banks, and has been widely applied to sales terminals in various types of stores, and has also been utilized for general work. Such a touch panel is configured to either malfunction or select any one of two or a multiple of touches using a preset program when two or a multiple of touches occur.

That is, referring to the upper drawing of FIG. 1, in a typical coordinate detection apparatus formed in the shape of a rectangle, light emitting sensors and photodetection sensors are installed on left and right sides to detect coordinates. Accordingly, when two targets are set and the coordinates thereof are detected, two virtual points (in red) occur, and thus there is a problem in that it is impossible to detect the coordinates of the actual targets.

Therefore, in order to solve this problem, as shown in the lower drawing of FIG. 1, a plurality of light emitting sensors is additionally installed in a diagonal direction and is used to detect the coordinates of targets.

However, this scheme increases installation costs due to the additional installation of a large number of light emitting sensors. Further, since light emitting sensors are typically turned on only when required because of lifespan considerations, a large number of light emitting sensors become responsible for shortening the lifespan of products while increasing the maintenance costs thereof.

### SUMMARY OF THE INVENTION

Accordingly, the present invention has been made keeping in mind the above problems occurring in the prior art, and a first object of the present invention is to provide a coordinate measuring apparatus and method, which can detect the coordinates of two or more targets without causing errors.

A second object of the present invention is to provide a coordinate measuring apparatus and method, which can obtain the coordinates of two or more targets using a minimum number of light emitting units.

A third object of the present invention is to provide a coordinate measuring apparatus and method, which can easily measure the coordinates of two or more targets using path equations for light emitting units.

In accordance with a preferred embodiment of the present invention to accomplish the first object, there is provided a coordinate measuring apparatus, comprising a plurality of photodetection units arranged along edges of the coordinate measuring apparatus, two or more light emitting units spaced apart from one another by a predetermined distance, and a control unit for allowing the photodetection units to sequentially receive a light emission signal from each light emitting unit and storing paths of the light emission signal to the individual photodetection units in a form of path equations.

Further, in accordance with a preferred embodiment of the present invention to accomplish the second object, the light emitting units are arranged at individual corners of a rectangle, and the photodetection units are arranged on corresponding sides of the rectangle, at which they receive a light emission signal from each light emitting unit.

Further, in accordance with a preferred embodiment of the present invention to accomplish the third object, each of the path equations is represented by the following Equation and a number of path equations are stored, the number being identical to a number of light emitting units,

y=ax+b

where x and y are coordinates, b is an intercept of y, and a is a slope which is determined by the coordinates of the photodetection units relative to each light emitting unit.

Further, in accordance with a preferred embodiment of the present invention to accomplish the first and second objects, there is provided a coordinate measuring method, comprising (a) arranging a plurality of photodetection units along edges of a rectangle and arranging light emitting units at individual corners of the rectangle, (b) storing x and y coordinates of the photodetection units relative to each light emitting unit, (c) the photodetection units sequentially receiving a light emission signal generated by the light emitting unit, and (d) storing paths of the light emission signal to the individual photodetection units by calculating path equations using the x and y coordinates. Further, each of the path equations is represented by the following equation:

y=ax+b

where x and y are coordinates, b is an intercept of y, and a is a slope which is determined by the coordinates of the photodetection units relative to each light emitting unit.

Furthermore, in accordance with another preferred embodiment of the present invention to accomplish the above objects, there is provided a coordinate measuring method, comprising arranging a plurality of photodetection units along edges of a rectangle and arranging light emitting units at individual corners of the rectangle, storing x and y coordinates of the photodetection units relative to each light emitting unit, sequentially transmitting light emission signals from the light emitting units, and calculating path equations of relevant light emission signals using x and y coordinates of photodetection units which do not receive the light emission signals, and fixing coordinates of a point, having same x and same y coordinates for the light emission signals, as coordinates of a target by using the two or more path equations, wherein each of the path equations is represented by the following Equation:

y=ax+b

where x and y are coordinates, b is an intercept of y, and a is a slope which is determined by the coordinates of the photodetection units relative to each light emitting unit.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing a conventional coordinate detection method;

FIG. 2 is a block diagram illustrating a coordinate measuring apparatus according to an embodiment of the present invention;

FIG. 3 is a flowchart showing a path equation calculation method for measuring coordinates according to an embodiment of the present invention;

FIG. 4 is a flowchart showing a coordinate measuring method according to an embodiment of the present invention; and

FIGS. 5 to 13 are diagrams showing individual steps of the coordinate measuring method according to an embodiment of the present invention.

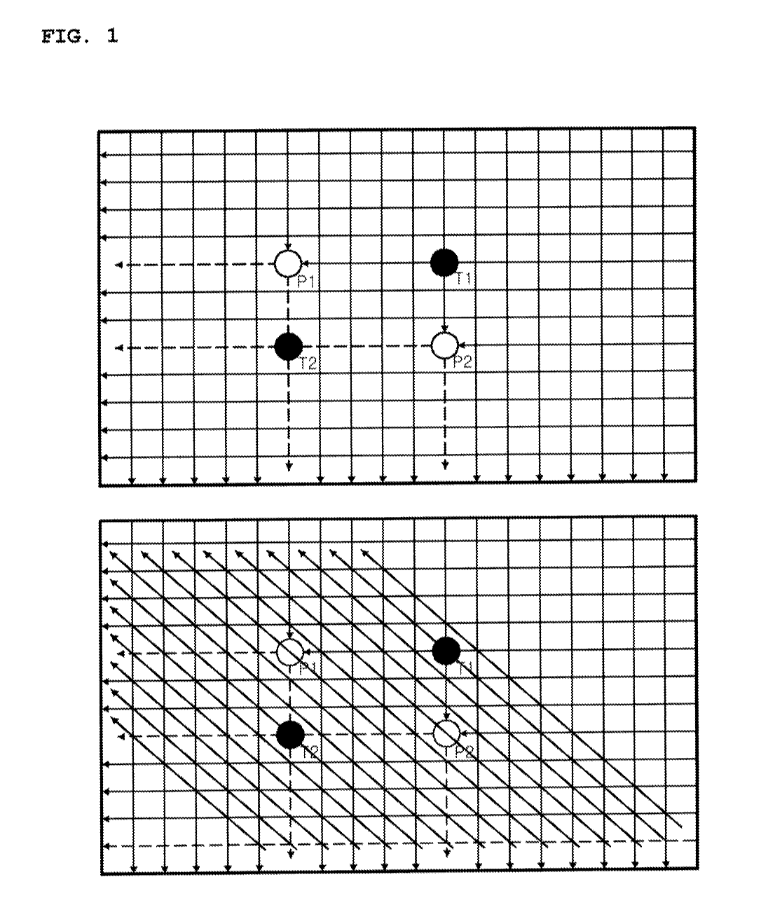

### DESCRIPTION OF THE PREFERRED EMBODIMENTS

The terms and words used in the present specification and claims should not be interpreted as being limited to their typical meaning based on the dictionary definitions thereof, but should be interpreted to have the meaning and concept relevant to the technical spirit of the present invention, on the basis of the principle by which the inventor can suitably define the implications of terms in the way which best describes the invention.

Hereinafter, embodiments of the present invention will be described in detail with reference to the attached drawings.

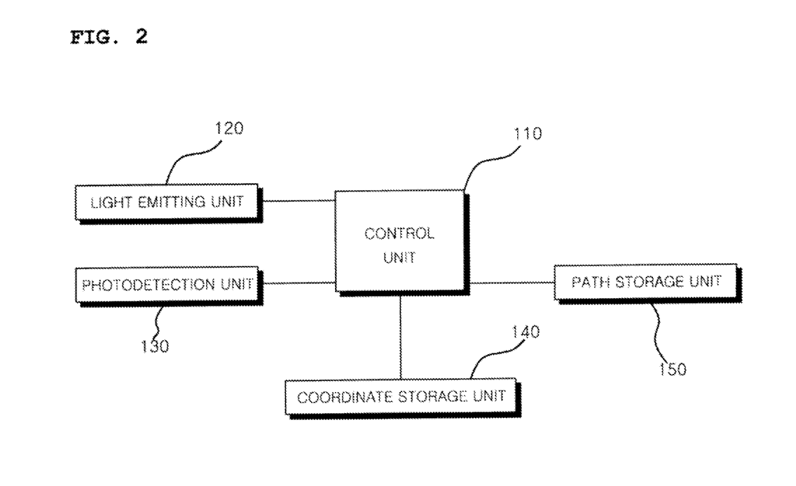

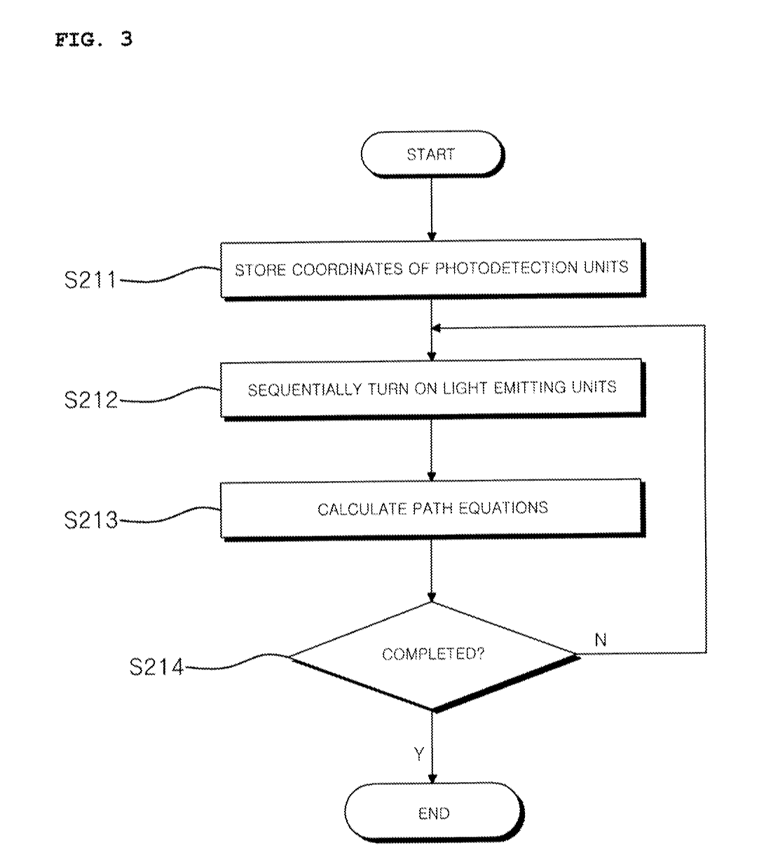

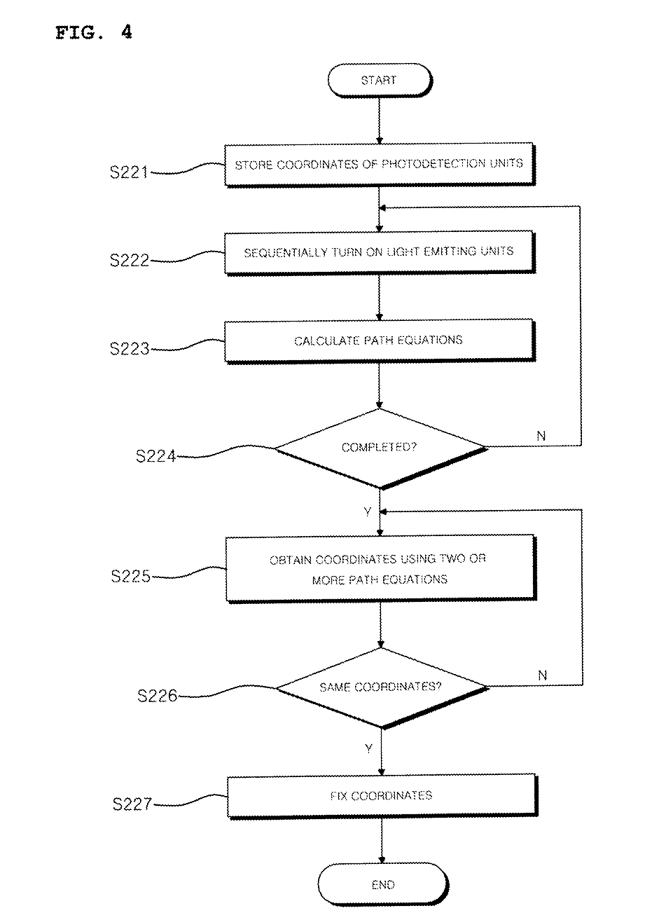

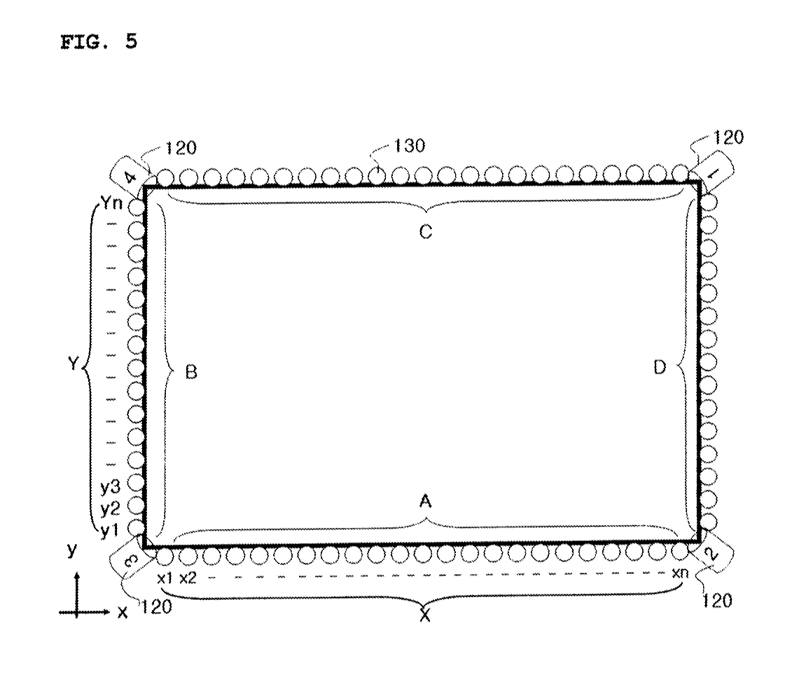

FIG. 2 is a block diagram illustrating a coordinate measuring apparatus according to an embodiment of the present invention, FIG. 3 is a flowchart showing a path equation calculation method for measuring coordinates according to an embodiment of the present invention, FIG. 4 is a flowchart showing a coordinate measuring method according to an embodiment of the present invention, and FIGS. 5 to 13 are diagrams showing individual steps of the coordinate measuring method according to an embodiment of the present invention.

The coordinate measuring apparatus according to an embodiment of the present invention includes a control unit 110, one or more light emitting units 120, one or more photodetection units 130, a coordinate storage unit 140 and a path storage unit 150.

The light emitting units 120 are installed to be spaced apart from one another by a predetermined distance in the coordinate measuring apparatus, and are installed at the individual corners of a rectangle if possible. The arrangement of the light emitting units 120 is implemented such that individual photodetection units 130, which are at corresponding locations, can receive a relevant light emission signal. Further, the light emitting units 120 are preferably implemented using infrared Light Emitting Diodes (LEDs) having excellent straightness.

The plurality of photodetection units 130 is arranged at corresponding locations so that they can sequentially receive a light emission signal from each light emitting unit 120.

The coordinate storage unit 140 stores the relative locations of the photodetection units 130 to each light emitting unit 120 in the form of x and y coordinates. Referring to FIG. 5, with respect to the light emitting unit 120 indicated by “1”, photodetection units 130 indicated by “A” and “B” and arranged at the relative locations of the light emitting unit “1” are designated using x and y coordinates on the basis of the light emitting unit 120 indicated by ‘1’. Similarly, with respect to the light emitting unit 120 indicated by “2”, photodetection units 130 indicated by “C” and “B” and arranged at the relative locations of the light emitting unit “2” are designated using x and y coordinates on the basis of the light emitting unit 120 indicated by ‘2’. Similarly, with respect to a light emitting unit 120 indicated by “3”, photodetection units 130 indicated by “C” and “D” and arranged at the relative locations of the light emitting unit “3” are designated using x and y coordinates on the basis of the light emitting unit 120 indicated by ‘3’. Further, with respect to a light emitting unit 120 indicated by “4”, photodetection units 130 indicated by “A” and “D” and arranged at the relative locations of the light emitting unit “4” are designated using x and y coordinates on the basis of the light emitting unit 120 indicated by ‘4’.

In detail, FIG. 5 illustrates an example of a coordinate measuring apparatus formed in the shape of a rectangle, wherein the width and height thereof are set as X and Y, and x and y denote the variable of an x axis and the variable of a y axis, respectively.

First, with respect to the light emitting unit 120 indicated by “1”, the x and y coordinates of photodetection units 130, which are indicated by “A” and “B” and are arranged at the relative locations of the light emitting unit 120, are stored. First, the x coordinates of the photodetection units 130, which are arranged at the relative locations of the light emitting unit 120 indicated by “1” and are arranged in “A”, that is, photodetection units xn, xn−1, xn−2, . . . , x2, x1, are sequentially stored at the same time that the y coordinates thereof are stored. In this case, the y coordinates of the photodetection units 130 arranged in “A” become the same value “Y”, so that the coordinates of the photodetection units 130 are stored in the form of (x,Y). Further, the y coordinates of the photodetection units 130 arranged in “B”, that is, the photodetection units y1, y2, . . . , yn, are sequentially stored at the same time that the x coordinates thereof are stored. In this case, the x coordinates of the photodetection units 130 arranged in “B” become the same value “X”, so that the coordinates of the photodetection units 130 are stored in the form of (X,y).

In the same manner, the x coordinates of the photodetection units 130 which are arranged at the relative locations of the light emitting unit 120 indicated by “2” and are arranged in “C”, that is, the photodetection units xn, xn−1, xn−2, . . . , x2, x1, are sequentially stored at the same time that the same y coordinate value “Y” is stored. Accordingly, the coordinates of the photodetection units 130 are stored in the form of (x,Y). The x coordinate value “X” and the y coordinates of the photodetection units 130 arranged in “B”, that is, the photodetection units y1, y2, . . . , yn, are sequentially stored in the form of (X,y).

In the same manner, with respect to the light emitting unit 120 indicated by “3”, the coordinates of the photodetection units 130 which are indicated by “C” and are arranged at the relative locations of the light emitting unit 120 are stored in the form of (x,Y), and the coordinates of the photodetection units 130 which are indicated by “D” are stored in the form of (X,y). Further, with respect to the light emitting unit 120 indicated by “4”, the coordinates of the photodetection units 130 which are indicated by “A” and are arranged at the relative locations of the light emitting unit 120 are stored in the form of (x,Y), and the coordinates of the photodetection units 130 which are indicated by “D” are stored in the form of (X,y).

The path storage unit 150 is configured to calculate the path equations of individual photodetection units 130 relative to each light emitting unit 120 using the coordinates (x,y) stored in the coordinate storage unit 140.

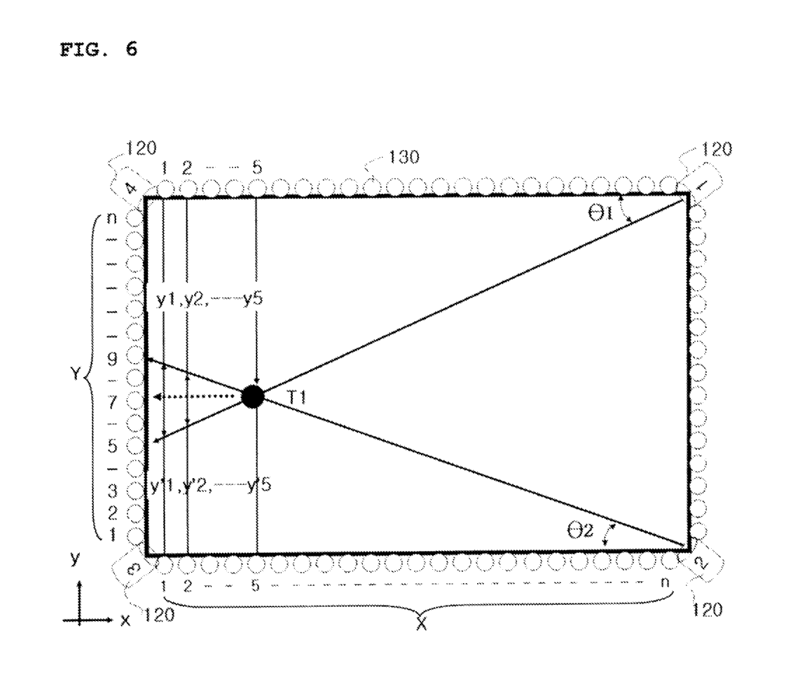

A detailed description will be made with reference to FIGS. 5 and 6. When the coordinates of a target T1 are obtained, an angle of the light emitting unit 120 indicated by “1” is gradually increased from 0 degrees in a counterclockwise direction around the horizontal axis of the light emitting unit 120, so that a photodetection unit by which a light emission signal is blocked is searched for in the photodetection units 130 indicated by “B”. This operation is required to obtain the coordinates of a photodetection unit which does not receive the light emission signal from the light emitting unit, due to the target. For example, in the case where other photodetection units receive the light emission signal and a photodetection unit indicated by “y5” does not receive the light emission signal, this means that the target is present on a path connecting the light emitting unit 120 indicated by “1” to the photodetection unit indicated by “y5”. The coordinates of the photodetection unit “y5” at that time are (X,y5), so that a path equation is represented by the following Equation (1).

Y=(y⁵/X)x (1)

That is, a linear equation having a slope of y5/X is obtained. Preferably, the criteria for changing the angle are given by increasing the angle to a degree in which each photodetection unit can receive a light emission signal from a relevant light emitting unit.

Further, when the target is located near a relevant light emitting unit, the photodetection units may not continuously receive a light emission signal. In this case, when three or more consecutive photodetection units do not receive the light emission signal from the relevant light emitting unit, a path equation for the relevant light emitting unit is ignored, and actual coordinates are obtained using path equations for other light emitting units.

Furthermore, in an embodiment of the present invention, a scheme for storing coordinates and obtaining path equations has been described, but those skilled in the art will appreciate that path equations can also be obtained by reading the angle θ₁ of the light emitting unit when the principles of sine and cosine functions are used or when the angle θ₁ is increased in advance so that each photodetection unit can receive the light emission signal from the light emitting unit.

As described above, after the path equation for the light emitting unit 120 indicated by “1” has been obtained, a path equation for the light emitting unit 120 indicated by “2” is obtained.

In this case, with respect to the target T1, the coordinates of the photodetection unit 130 “y9” relative to the light emitting unit 120 indicated by “2” are (X, y9), so that a path equation is represented by the following equation (2).

y=(y9/X)x (2)

In this way, when the path equations of the photodetection units relative to the light emitting units indicated by “1” and “2” are obtained, the coordinates (x,y) of the target T1 can be consequently obtained by solving linear equations based on the two path equations.

Methods of obtaining solutions to the linear equations are well known, so that a detailed description thereof is omitted, and a method using coordinates, which is a simple method, will be described below.

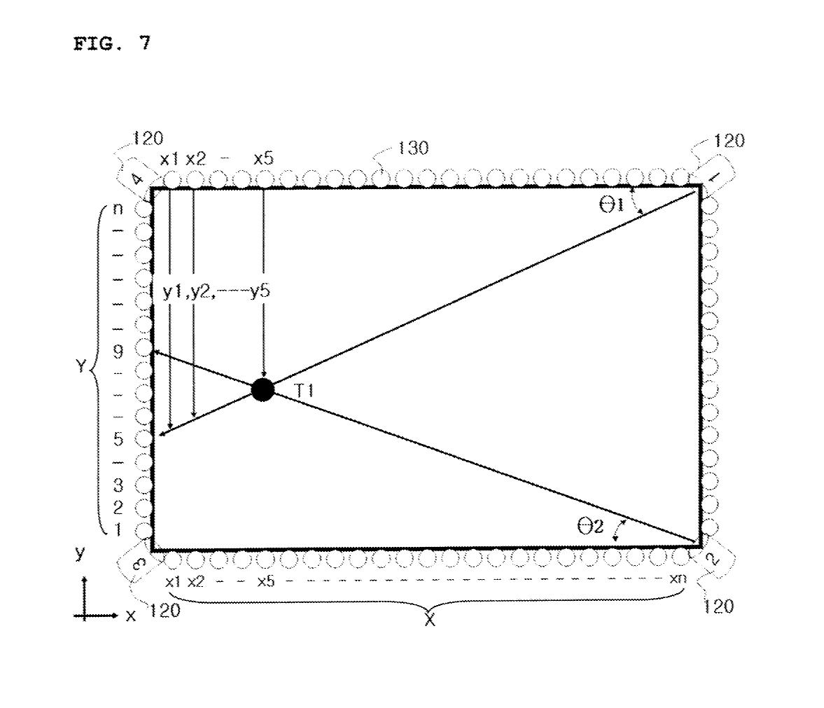

A detailed description will be made with reference to FIGS. 7 to 9. In relation to the path equation for the light emitting unit indicated by “1”, that is, y=(y5/X)x, there are coordinate points (x1,y1), (x2,y2), (x3,y3), (x4,y4), (x5, y5), etc. (refer to FIG. 7).

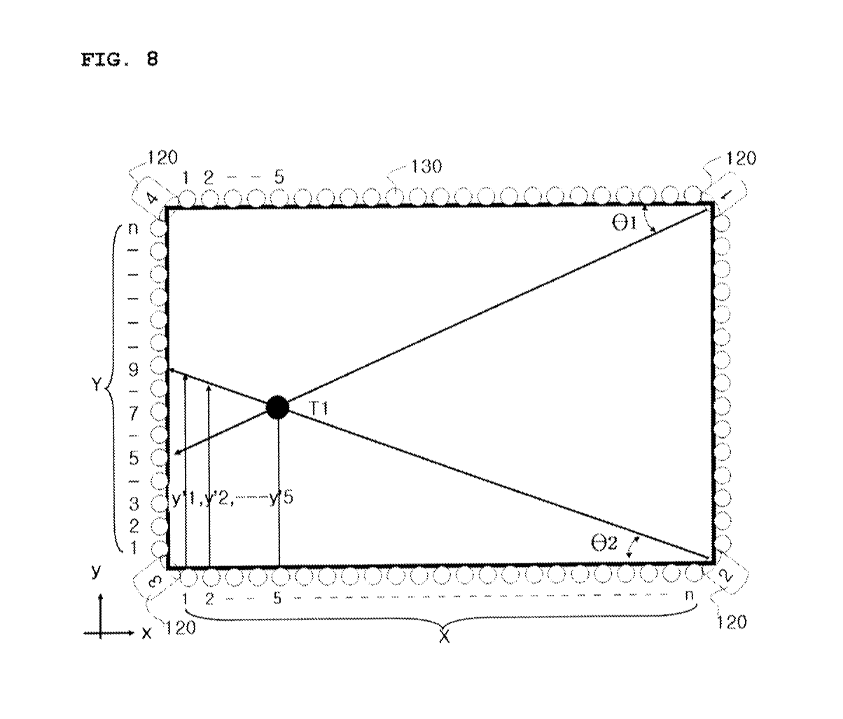

Further, in relation to the path equation for the light emitting unit indicated by “2”, that is, y=(y9/X)x, there are coordinate points (x1,y′1), (x2,y′2), (x3,y′3), (x4,y′4), (x5,y′5), etc. (refer to FIG. 8).

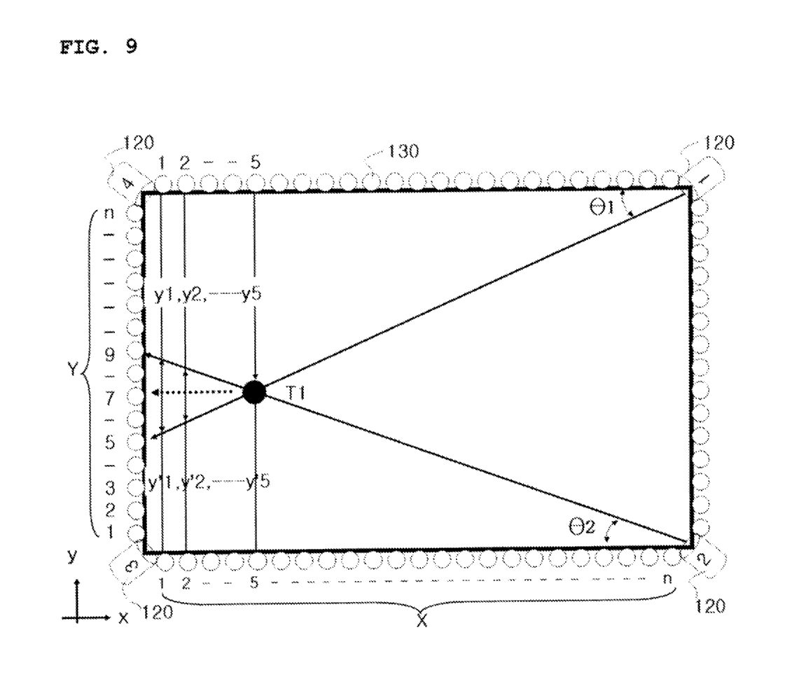

The x coordinates of the photodetection units relative to the individual light emitting units 120 are identical, and the total length of the y axis is given by Y=y5+y′5. Accordingly, when a coordinate point satisfying Y=y5+y′5 is found while the x coordinate is gradually increased, the coordinates of the target are consequently obtained as (x5,y7) (refer to FIG. 9).

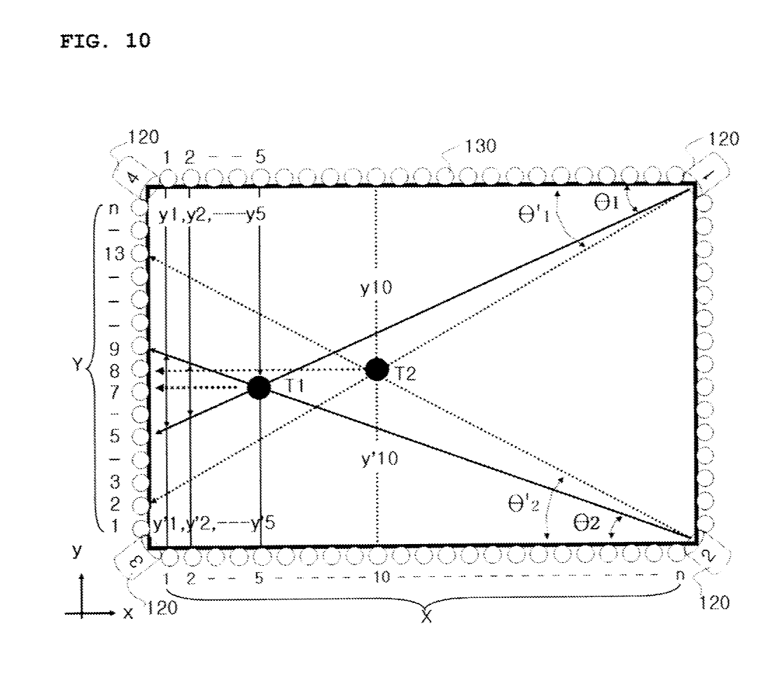

As described above, when there is one target, one path equation is calculated for each of light emitting units, so that the coordinates of the target can be obtained. However, when there are two targets, as shown in FIG. 10, path equations for one light emitting unit intersect path equations for another light emitting unit, so that two virtual points are generated.

Due to these virtual points, many difficulties occur when calculating the coordinates of actual targets.

The present invention is devised to solve the problems of virtual points, and is configured such that when there are two or more path equations for one or more light emitting units, the coordinates of actual targets, not the coordinates of virtual points, can be obtained using a third light emitting unit.

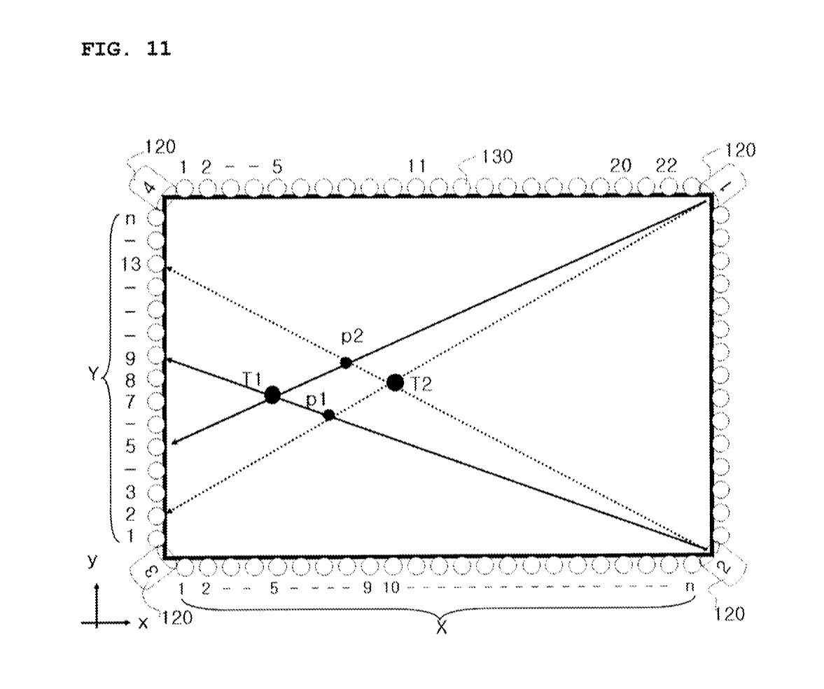

A detailed description will be made with reference to FIG. 11. When, with respect to actual targets T1 and T2, the light emitting units 120 indicated by “1” and “2” transmit light emission signals, virtual points such as p1 and p2 are generated, thus making it impossible to calculate the coordinates of the actual targets. That is, two virtual points at which two path equations intersect each other are additionally generated. Accordingly, when the coordinates of the actual targets are obtained, the coordinates are calculated as if there are four targets.

In detail, with respect to the target T1, the respective path equations for the light emitting units 120 indicated by “1” and “2” are y=(y5/X)x and y=(y9/X)x, and with respect to the target T2, the respective path equations for the light emitting units 120 indicated by “1” and “2” are y=(y2/X)x and y=(y13/X)x. That is, the four path equations represented by y=(y5/X)x, y=(y9/X)x, y=(y2/X)x and y=(y13/X)x are obtained.

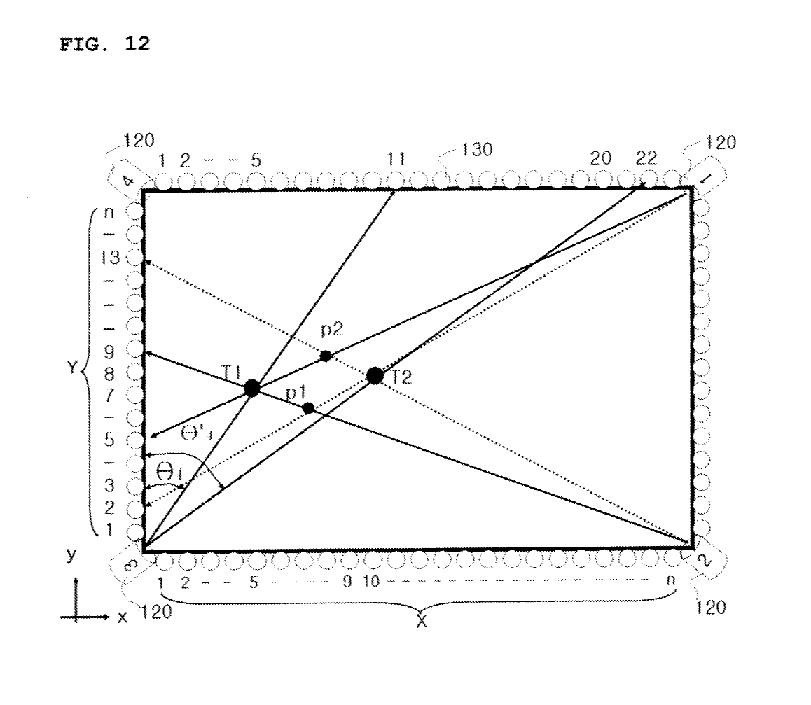

When linear equations based on the path equations are solved, the actual targets T1 and T2 and virtual points p1 and p2 are obtained, as shown in FIG. 12.

Therefore, when two or more path equations are generated for one or more light emitting units, other path equations are obtained using a third light emitting unit, thus enabling the coordinates of the actual targets T1 and T2 to be obtained.

Referring to FIG. 12, with respect to each of the targets T1 and T2, two path equations for the light emitting units 120 indicated by “1” and “2” are obtained, and then a path equation for the light emitting unit 120 indicated by “3” is further obtained using the same method, as described above. Thereafter, when the coordinates of points at which the x and y coordinates of three path equations are respectively identical are obtained, the coordinates of each actual target can be obtained.

That is, the coordinates of points through which three path equations simultaneously pass are the coordinates of the actual targets. Referring to FIG. 12, it can be seen that in the case of the virtual points p1 and p2, two path equations simultaneously pass through each of the virtual points p1 and p2, but the path equations for the light emitting unit 120 indicated by “3” do not pass through those virtual points p1 and p2.

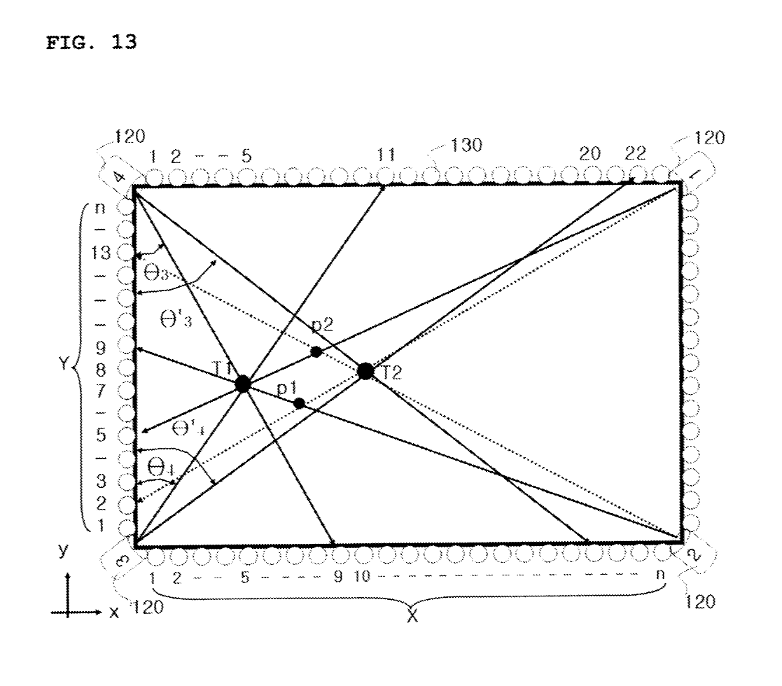

As shown in FIG. 13, when path equations for a light emitting unit 120 indicated by “4” are obtained using the same method and are used to calculate coordinates, the coordinates of actual targets can be more reliably obtained.

Hereinafter, a method of calculating path equations according to an embodiment of the present invention will be described with reference to FIG. 3.

FIG. 3 is a flowchart showing a path equation calculation method for measuring coordinates according to an embodiment of the present invention.

First, by using the coordinate measuring apparatus in which a plurality of photodetection units is arranged along the edges of a rectangle and light emitting units are arranged at the individual corners of the rectangle, the x and y coordinates of the photodetection units relative to each of the light emitting units are stored at step S211.

In detail, the coordinate storage unit 140 stores the relative locations of the photodetection units 130 to each of the light emitting units 120 in the form of x and y coordinates. Referring to FIG. 5, with respect to the light emitting unit 120 indicated by “1”, photodetection units 130 indicated by “A” and “B” and arranged at the relative locations of the light emitting unit “1” are designated using x and y coordinates on the basis of the light emitting unit 120 indicated by ‘1’. Similarly, with respect to the light emitting unit 120 indicated by “2”, photodetection units 130 indicated by “C” and “B” and arranged at the relative locations of the light emitting unit “2” are designated using x and y coordinates on the basis of the light emitting unit 120 indicated by ‘2’. Similarly, with respect to a light emitting unit 120 indicated by “3”, photodetection units 130 indicated by “C” and “D” and arranged at the relative locations of the light emitting unit “3” are designated using x and y coordinates on the basis of the light emitting unit 120 indicated by ‘3’. Further, with respect to a light emitting unit 120 indicated by “4”, photodetection units 130 indicated by “A” and “D” and arranged at the relative locations of the light emitting unit “4” are designated using x and y coordinates on the basis of the light emitting unit 120 indicated by ‘4’.

When the designation of the coordinates of the photodetection units 130 relative to each light emitting unit 120 has been completed, the light emitting units 120 are sequentially turned on at step S212, and thus path equations are calculated at step S213.

Steps S212 and S213 are described in detail as follows. When the photodetection units 130 sequentially receive a light emission signal generated by a relevant light emitting unit 120, the paths of the light emission signal to the individual photodetection units 130 are stored by calculating path equations using x and y coordinates.

As described above, each of the path equations at that time is obtained as a linear equation having a form of y=ax+b, where x and y are coordinates, b is an intercept of y, and a is a slope which is determined by the coordinates of the photodetection units relative to each light emitting unit.

At step S214, whether the calculation of path equations of the photodetection units 130 relative to each light emitting unit 120 has been completed is determined. If it is determined that the calculation of the path equations has been completed, the process is terminated, whereas if it is determined that the calculation of the path equations is currently being performed, path equations are obtained by repeating a procedure starting from step S212, and then the process is terminated.

Hereinafter, a method of calculating path equations and measuring coordinates using the calculated path equations according to an embodiment of the present invention will be described with reference to FIG. 4.

By using the coordinate measuring apparatus in which a plurality of photodetection units is arranged along the edges of a rectangle and light emitting units are arranged at the individual corners of the rectangle, the x and y coordinates of the photodetection units relative to each light emitting unit are stored at step S221.

When the designation of the coordinates of the photodetection units 130 relative to each light emitting unit 120 has been completed, the light emitting units 120 are sequentially turned on at step S222, so that path equations are calculated and stored at step S223.

Steps S222 and S223 are the same as the above-described steps S212 and S213, and thus a detailed description thereof is omitted.

At step S224, whether the calculation of path equations of the photodetection units 130 relative to each light emitting unit 120 has been completed is determined. If it is determined that the calculation of the path equations has been completed, the process proceeds to step S225, whereas if it is determined that the calculation of the path equations is currently being performed, a procedure starting from step S222 is repeated until all path equations are calculated.

All of the path equations of the photodetection units 130 relative to each light emitting unit 120 have been calculated at step S224. Thereafter, the light emission signals are sequentially transmitted again from the light emitting units 120, so that the path equations of relevant light emission signals are calculated using the x and y coordinates of photodetection units 130 which do not receive the light emission signals, and the coordinates of a target are obtained using two or more path equations at step S225.

A detailed description will be made below with reference to FIGS. 5 and 6. When the coordinates of a target T1 are obtained, an angle of a light emitting unit 120 indicated by “1” is gradually increased from 0 degrees in a counterclockwise direction around a horizontal axis, and thus a photodetection unit by which a light emission signal is blocked is searched for.

This operation is required to obtain the coordinates of a photodetection unit which does not receive the light emission signal from the light emitting unit due to the target. For example, in the case where other photodetection units receive the light emission signal and a specific photodetection unit indicated by “y5” does not receive the light emission signal, this means that the target is present on the path connecting the light emitting unit 120 indicated by “1” to the photodetection unit indicated by “y5”. The coordinates of the photodetection unit “y5” at that time are (X,y5), and thus a path equation is represented by the above-described Equation (1).

That is, a linear equation having a slope of y5/X is obtained.

Preferably, the criteria for changing the angle are given by increasing the angle to a degree in which each photodetection unit can receive a light emission signal from a relevant light emitting unit.

Further, when the target is located near a relevant light emitting unit, the photodetection units may not continuously receive a light emission signal. In this case, when three or more consecutive photodetection units do not receive the light emission signal from the relevant light emitting unit, a path equation for the relevant light emitting unit is ignored, and actual coordinates are obtained using path equations for other light emitting units.

Furthermore, in an embodiment of the present invention, a scheme for storing coordinates and obtaining path equations has been described, but those skilled in the art will appreciate that path equations can also be obtained by reading the angle θ₁ of the light emitting unit when the principles of sine and cosine functions are used or when the angle θ₁ is increased in advance so that each photodetection unit can receive the light emission signal from the light emitting unit.

As described above, after the path equation for the light emitting unit 120 indicated by “1” has been obtained, a path equation for the light emitting unit 120 indicated by “2” is obtained.

In this case, with respect to the target T1, the coordinates of the photodetection unit 130 indicated by “y9” relative to the light emitting unit 120 indicated by “2” are (X,y9), and thus a path equation is represented by the above-described Equation (2).

As described above, when the path equations of the photodetection units relative to the light emitting units indicated by “1” and “2” are obtained, the coordinates (x, y) of the target T1 can be consequently obtained by solving linear equations based on the two path equations.

When the path equations are obtained with respect to the target, the individual equations are solved to determine whether a point having the same coordinate values exists at step S226. The coordinates of the point at step S226 are fixed as the coordinates of the target at step S227. Further, when no point having the same coordinate values exists, a procedure starting from step S225 is repeated.

Further, when there is one target, one path equation is calculated for each light emitting unit, so that the coordinates of the target can be easily obtained. However, when there are two targets, as shown in FIG. 10, path equations for respective light emitting units intersect each other, so that two virtual points are generated.

Due to such virtual points, many difficulties occur when calculating the coordinates of the actual targets.

The present invention is devised to solve the problems of is virtual points, and is configured such that when there are two or more path equations for one or more light emitting units, the coordinates of actual targets, not the coordinates of virtual points, can be obtained using a third light emitting unit.

A detailed description will be made with reference to FIG. 11. When, with respect to actual targets T1 and T2, the light emitting units 120 indicated by “1” and “2” transmit light emission signals, virtual points such as p1 and p2 are generated, thus making it impossible to calculate the coordinates of the actual targets. That is, two virtual points at which two path equations intersect each other are additionally generated. Accordingly, when the coordinates of the actual targets are obtained, the coordinates are calculated as if there are four targets.

In detail, with respect to the target T1, the respective path equations for the light emitting units 120 indicated by “1” and “2” are y=(y5/X)x and y=(y9/X)x, and with respect to the target T2, the respective path equations for the light emitting units 120 indicated by “1” and “2” are y=(y2/X)x and y=(y13/X)x.

That is, the four path equations represented by y=(y5/X)x, y=(y9/X)x, y=(y2/X)x and y=(y13/X)x are obtained.

When linear equations based on the path equations are solved, the actual targets T1 and T2 and virtual points p1 and p2 are obtained, as shown in FIG. 12.

Therefore, when two or more path equations are generated for one or more light emitting units, other path equations are obtained using a third light emitting unit, thus enabling the coordinates of the actual targets T1 and T2 to be obtained.

Referring to FIG. 12, with respect to each of the targets T1 and T2, two path equations for the light emitting units 120 indicated by “1” and “2” are obtained, and then a path equation for the light emitting unit 120 indicated by “3” is further obtained using the same method, as described above. Thereafter, when the coordinates of points at which the x and y coordinates of three path equations are respectively identical are obtained, the coordinates of each actual target can be obtained.

That is, the coordinates of points through which three path equations simultaneously pass are the coordinates of the actual targets. Referring to FIG. 12, it can be seen that in the case of the virtual points p1 and p2, two path equations simultaneously pass through each of the virtual points p1 and p2, but the path equations for the light emitting unit 120 indicated by “3” do not pass through those virtual points p1 and p2.

The present invention relates, in general, to a coordinate detection method and apparatus, and, more particularly, to a coordinate measuring apparatus and method, which can generate the coordinates of one or more actual target objects while using a small number of light emitting sensors. Accordingly, since the coordinates of virtual points are not generated, the coordinates of targets can be easily and precisely detected. Further, since the number of sensors can be reduced, precise coordinate measuring apparatuses can be produced at low cost.

As described above, the present invention is advantageous in that the coordinates of two or more targets are calculated using equations, so that the coordinates of virtual points are not generated, thus enabling the coordinates of actual targets to be easily and precisely detected.

Further, the present invention is advantageous in that a small number of light emitting units are used, so that the number of sensors can be reduced compared to a conventional coordinate detection apparatus, thus not only enabling precise coordinate measuring apparatuses to be produced at low cost, but also enabling the maintenance of coordinate measuring apparatuses to be performed at low cost.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A coordinate measuring apparatus, comprising:
a plurality of photodetection units arranged along edges of the coordinate measuring apparatus;
two or more light emitting units spaced apart from one another by a predetermined distance; and
a control unit for allowing the photodetection units to sequentially receive a light emission signal from each light emitting unit and storing paths of the light emission signal to the individual photodetection units in a form of path equations.

2. The coordinate measuring apparatus according to claim 1, wherein the light emitting units are arranged at individual corners of a rectangle, and the photodetection units are arranged on corresponding sides of the rectangle, at which they receive a light emission signal from each light emitting unit.

3. The coordinate measuring apparatus according to claim 2, wherein each of the path equations is represented by the following Equation:
y=ax+b
where x and y are coordinates, b is an intercept of y, and a is a slope which is determined by the coordinates of the photodetection units relative to each light emitting unit.

4. The coordinate measuring apparatus according to claim 3, wherein the control unit stores a number of path equations, the number being identical to a number of light emitting units, for each target.

5. A path equation calculation method for measuring coordinates, comprising:
(a) arranging a plurality of photodetection units along edges of a rectangle and arranging light emitting units at individual corners of the rectangle;
(b) storing x and y coordinates of the photodetection units relative to each light emitting unit;
(c) the photodetection units sequentially receiving a light emission signal generated by the light emitting unit; and
(d) storing paths of the light emission signal to the individual photodetection units by calculating path equations using the x and y coordinates.

6. The path equation calculation method according to claim 5, wherein each of the path equations at (d) is represented by the following equation:
y=ax+b
where x and y are coordinates, b is an intercept of y, and a is a slope which is determined by the coordinates of the photodetection units relative to each light emitting unit.

7. A coordinate measuring method, comprising:
arranging a plurality of photodetection units along edges of a rectangle and arranging light emitting units at individual corners of the rectangle;
storing x and y coordinates of the photodetection units relative to each light emitting unit;
sequentially transmitting light emission signals from the light emitting units, and calculating path equations of relevant light emission signals using x and y coordinates of photodetection units which do not receive the light emission signals; and
fixing coordinates of a point, having same x and same y coordinates for the light emission signals, as coordinates of a target by using the two or more path equations,
wherein each of the path equations is represented by the following Equation:
y=ax+b
where x and y are coordinates, b is an intercept of y, and a is a slope which is determined by the coordinates of the photodetection units relative to each light emitting unit.
